(19) United States
(12) Patent Application Publication
(10) Pub. No.: US 2015/0058296 A1
(43) Pub. Date: Feb. 26, 2015

(54) DATA STORAGE METHOD AND COMPUTING DEVICE USING SAME

(71) Applicant: HON HAI PRECISION INDUSTRY CO., LTD., New Taipei (TW)

(72) Inventors: JUI-LUNG LIN, New Taipei (TW); ZHEN-HONG WU, New Taipei (TW); KUO-YUAN CHANG, New Taipei (TW)

(21) Appl. No.: 14/466,598

(22) Filed: Aug. 22, 2014

(30) Foreign Application Priority Data
Aug. 26, 2013 (TW) 102130461

(51) Int. Cl. G06F 17/30; G06F 11/14

(52) U.S. Cl. CPC G06F 17/30221; G06F 11/1448
USPC 707/651

(57) ABSTRACT

A data storage method for a computing device is disclosed. The method includes: receiving, at a computing device, a file and a profile, wherein the profile includes a level of magnitude; storing, at the computing device in a first database, the file if the level of magnitude is greater than the lowest level; storing, at the computing device in a second database, the file if the level of magnitude is the highest level; and deleting, at the server, the file if the level of magnitude is the lowest.

### CROSS-REFERENCE TO RELATED APPLICATIONS

This application claims priority to Taiwan Patent Application No. 102130461 filed on Aug. 26, 2013 in the Taiwan Intellectual Property Office, the contents of which are incorporated by reference herein.

### FIELD

The subject matter herein generally relates to a method for data storage and a computing device using the method.

### BACKGROUND

Client devices, for example, smart phones, or tablet computers, become more and more popular. The client devices can be figured to allow a user to back up data to a computing device having a storage space and download data from the computing device. In general, client devices are coupled to a computing device via a network to obtain data from and transmit data to the computing device. The storage space of the computing device is limited. There is a need to delete redundant or useless data stored in the storage device when the storage space of the storage device is full.

### BRIEF DESCRIPTION OF THE DRAWINGS

Implementations of the present technology will now be described, by way of example only, with reference to the attached figures, wherein:

FIG. 1 is an isometric diagram of an exemplary embodiment of a computing device in an exemplary use environment.

FIG. 2 is a block diagram of an exemplary embodiment of a data storage system.

FIG. 3 is a flowchart of an exemplary embodiment of a data storage method.

FIG. 4 is a flowchart of an exemplary embodiment of a method for updating level of magnitude of a data file.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a method of data storage in a computing device 1.

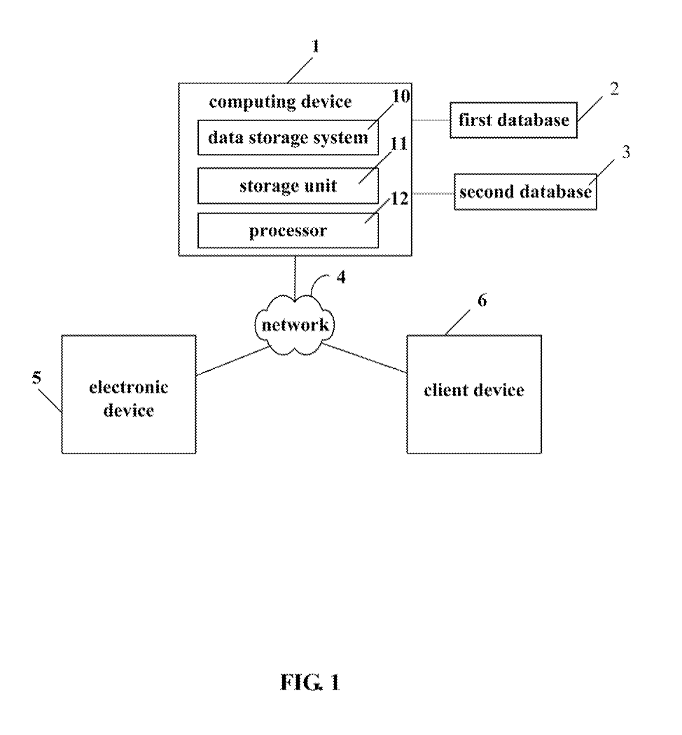

FIG. 1 illustrates an isometric diagram of an exemplary embodiment of a computing device in an exemplary use environment. The computing device 1 can be configured to be coupled to a plurality of electronic devices 5 and at least one client device 6 by a network 4.

The computing device 1 can be a server or a general computer. The network 4 can be the Internet, GPRS, Wi-Fi/WLAN, WCDMA, HDSPA, or other public accessible networks. The electronic devices 5 can be personal computers (PCs), tablet PC, smart phones or video cameras.

A first database 2 and a second database 3 can be configured to be coupled to the computing device 1. The first or second database 2, 3 can be a built-in storage unit of the computing device, or an independent database, for example, SQL database, open database connectivity (ODBC), or Java database connectivity (JDBC). The computing device 1 can be configured to receive data from the electronic devices 5 and store the received data into the first database 2. The second database 3 can be configured as a backup of the first database 2 and can be configured to store data of great importance stored in the first database 2. The computing device 1 further can be configured to communicate with the client device 6 so as to enable the client device 4 to search, download or update data stored in the first database 2 and the second database 3.

The data stored in the first database 2 can includes one or more data files. Each data file has a profile. The profile can include at least one level of magnitude, at least one related efficient time period, and updating time of level. The efficient time period for a level of magnitude means a time period during which the level of magnitude is efficient. The updating time of level means a time when a level of magnitude being changed to another level of magnitude. Each level of magnitude can be related to one related efficient time period. In other words, each level of magnitude takes effect only during the related efficient time period. The level of magnitude can be changed to another level of magnitude outside of the related efficient time period. For example, a data file 's level of magnitude is A in a first efficient time period D1 (from t0 to t1) and the data file's level of magnitude is B in a second efficient time period D2 (from t1 to t2). The level A is effective only in the first efficient time period D1 and the level B is effective only in the second efficient time period D2. The level of magnitude of the data file is updated at t1. In other words, the updating time of level is t1. For convenience of description, in the following exemplary embodiments, it is assumed that there can be four levels of magnitude A, B, C, and D indicating the importance of the data file of that level is in a decreased order. Level A represents that the data file is the most important and Level D represents that the data file is the least important. The level of magnitude of the data file can be changed from a higher level to a lower level, for example, from A to B or C or D, from B to C or D, from C to D.

The level of magnitude can be pre-defined by a user. In at least one embodiment, the level of magnitude can be updated automatically based on pre-defined rules. The pre-defined rules can include levels of magnitude, efficient time period of each level, updating time of level. For example, if the electronic device is a monitoring camera, the video obtained by the monitoring camera can be stored as a plurality of video files. Video files obtained during a predetermined time period in which a possibility of dangerous occurring is relatively high, for example, midnight, can be given a higher level, for example, A. The efficient time of level A can be a week. The level of magnitude of the video file can be changed to B a week later. So, the pre-defined rule for the video file is: initial level: A, efficient time: 7 days, update time: 8th day, updated level: B

The computing device 1 can include a processor 11 and a storage unit 12. A data storage system 10 can include computerized instructions in the form of one or more programs that are executed by the processor 11 and stored in the storage unit 12.

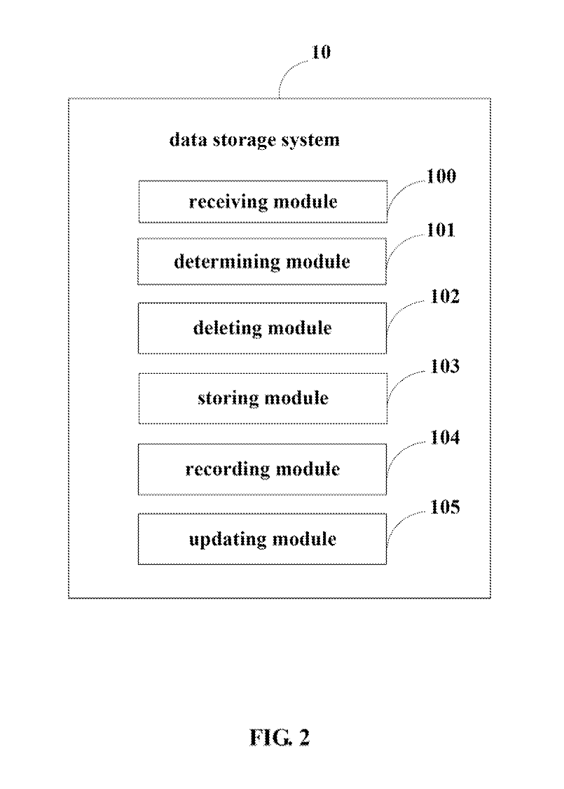

FIG. 2 illustrates a block diagram of an exemplary embodiment of a data storage system. The data storage system 10 can include one or more modules, for example, a receiving module 100, a determining module 101, a deleting module 102, a storing module 103, a recording module 104, and an updating module 105. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The receiving module 100 can be configured to receive data files from electronic devices 5. The determining module 101 can be configured to determine the level of an incoming data file. The deleting module 102 can be configured to delete data files having a lower level of magnitude. The storing module 103 can be configured to store data into a database. The recording module 104 can be configured to record updating time of level. The updating module 105 can be configured to update level of magnitude.

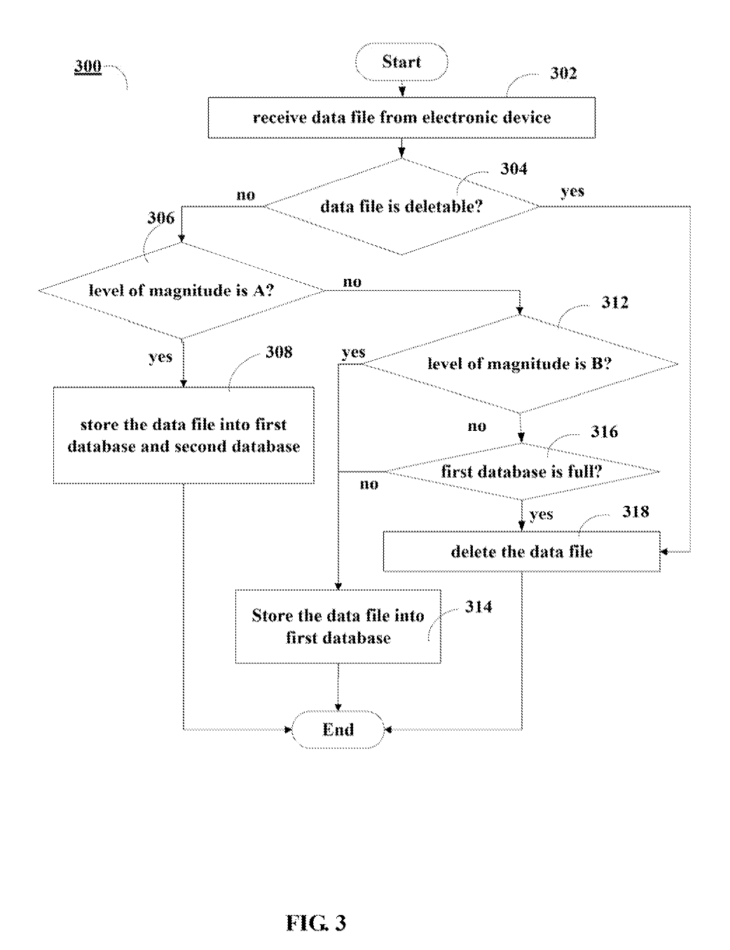

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1, and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 illustrates a flowchart of an exemplary embodiment of a data storage method for a computing device, and can begin at block 302.

At block 302, the computing device receives a data file from an electronic device. The data file has a profile. The profile of the data file can include at least one level of the data file, efficient time period for each level, updating time of each level.

At block 304, the computing device determines whether the data file is deletable based on the profile of the data file. In the exemplary embodiment, if the level of magnitude of the data file is D, the data file is determined deletable. The procedures proceeds to block 306 if the data file is not deletable, otherwise the procedures goes to block 318.

At block 306, the computing device determines whether the level of magnitude of the data file is A. The procedures goes to block 308 if the level of the data file is A, otherwise the procedure goes to block 312.

At block 308, the data file is stored into both a first database and a second database.

At block 312, the computing device determines whether the level of magnitude of the data file is B. The procedure goes to block 314 if the level of magnitude of the data file is B, otherwise the procedure goes to block 316.

At block 314, the computing device stores the data file into the first database.

At block 316, the computing device determines whether the first database is full. The procedure goes to block 318 if the first database is full, otherwise, the procedures goes to block 314.

At block 318, the computing device deletes the data file.

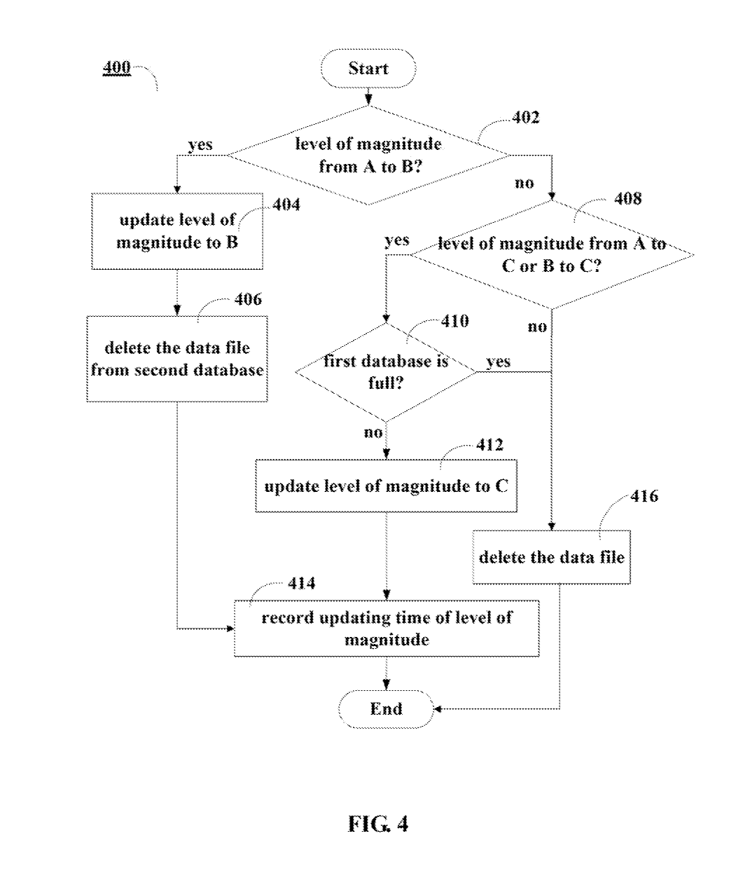

Referring to FIG. 4, an exemplary level updating method 400 for updating level of a data file is illustrated. In order for convenience of description, it is assumed that each data file has a profile. The profile defines at least one level of magnitude. There can be four levels of magnitude A, B, C, and D indicating the importance of the data file of that level is in a decreased order. Level A represents that the data file is the most important and Level D represents that the data file is the least important. The profile further defines an updating rule which enables the level of a data file to be changed automatically to a predetermined level at a predetermined time. The level of magnitude of the data file can be changed from a higher level to a lower level, for example, from A to B or C or D, from B to C or D, from C to D. When the level of a data file is to be changed, the exemplary level updating method 400 can be executed. The exemplary level updating method 400 can begin at block 402.

At block 402, the computing device determines whether the level of magnitude of the data file is to be changed from A to B based on the profile of the data file. The procedure goes to block 404 if the level of magnitude of the data file is to be changed from A to B, otherwise, the procedure proceeds to block 408.

At block 404, the computing device updates the level of magnitude of the data file to B.

At block 406, the computing device deletes the data file from the second database.

At block 408, the computing device determines whether the level of magnitude of the data file is to be changed from A to C or from B to C. The procedure proceeds to block 410 if the level of magnitude of the data file is to be changed from A to C or from B to C. If the level of magnitude of the data file is not to be changed from A to C or from B to C, that means, the level of the data file is to be changed from A to D, B to D or C to D, the procedure will go to block 416.

At block 410, the computing device determines whether the first database is full.

At block 412, the computing device updates the level of magnitude of the data file to C.

At block 414, the computing device records an updating time of the level of magnitude of the data file.

At block 416, the computing device deletes the data file.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A data storage method for a computing device, the method comprising:
receiving, at the computing device, a data file from an electronic device, the data file having a profile, the profile including a level of magnitude of the data file;
deleting, at the computing device, the data file if the level of magnitude equals the lowest level of magnitude; and
storing, at the computing device, the data file into a first database if the level of magnitude indicates any level of magnitude other than the lowest level.

2. The method according to claim 1, wherein the level of magnitude of the data file is one of:
a first level indicating the data file of that level is most important, a second level indicating the data file of that level is secondary important, a third level indicating the data file of that level is common, and a forth level indicating the data file of that level is deletable.

3. The method according to claim 2, further comprising: storing the data file into a second database if the level of magnitude of the data file is the first level.

4. The method according to claim 3, wherein the profile of the data file includes at least two levels of magnitude, and efficient time period for each level, the method further comprising:
updating the level of magnitude of the data file if the efficient time period for a current level is expired; and
recording an updating time of level into the profile of the data file.

5. The method according to claim 4, wherein the level of magnitude of the data file is changeable from a higher level to a lower level, and the updating comprising:
determining whether the level of magnitude is to be changed to the second level;
determining whether the level of magnitude is to be changed to the third level if the level of magnitude is not to be changed to the second level;
determining whether the first database is full if the level of magnitude is to be changed to the third level;
updating the level of magnitude of the data file to the third level if the first database is not full;
deleting the data file from the first database if the first database is full or the level of magnitude is not to be changed to the third level; and
updating the level of magnitude to the second level and deleting the data file from the second database if the level of magnitude is to be changed to the second level.

6. The method according to claim 2, further comprising: deleting the data file if the level of magnitude of the data file is the third level and the first database is full.

7. A computing device, comprising:
a storage unit for storing instructions;
a processor for executing the instructions to performing a method, the method comprising:
receive a data file from an electronic device, the data file having a profile, the profile including a level of magnitude of the data file;
delete the data file if the level of magnitude indicates that the data file is deletable; and
store the data file into a first database if the level of magnitude indicates that the data file is non-deletable.

8. The computing device according to claim 7, wherein the level of magnitude of the data file is one of: a first level indicating the data file of that level is most important, a second level indicating the data file of that level is secondary important, a third level indicating the data file of that level is common, and a forth level indicating the data file of that level is deletable.

9. The computing device according to claim 8, further comprising: storing the data file into a second database if the level of magnitude of the data file is the first level.

10. The computing device according to claim 9, wherein the profile of the data file includes at least two levels of magnitude, and efficient time period for each level, the method comprising:
updating the level of magnitude of the data file if the efficient time period for a current level is expired; and
recording an updating time of level into the profile of the data file.

11. The computing device according to claim 10, wherein the level of magnitude of the data file is changeable from a higher level to a lower level, causing the processor to:
determine whether the level of magnitude is to be changed to the second level;
determine whether the level of magnitude is to be changed to the third level if the level of magnitude is not to be changed to the second level;
determine whether the first database is full if the level of magnitude is to be changed to the third level;
update the level of magnitude of the data file to the third level if the first database is not full;
delete the data file from the first database if the first database is full or the level of magnitude is not to be changed to the third level; and
update the level of magnitude to the second level and deleting the data file from the second database if the level of magnitude is to be changed to the second level.

12. The method according to claim 8, further comprising: deleting the data file if the level of magnitude of the data file is the third level and the first database is full.

13. A method for storing a file based on hierarchal system comprising:
receiving, at a server, a file and a profile, wherein the profile includes a level of magnitude;
storing, at the server in a first database, the file if the level of magnitude is greater than the lowest level;
storing, at the server in a second database, the file if the level of magnitude is the highest level; and
deleting, at the server, the file if the level of magnitude is the lowest.

14. The method according to claim 13, further comprising:
updating, at the server, the current level of magnitude to a predetermined level based on the profile of the file, the profile of the file defines an level updating rule which enables the level of the file to be changed to a predetermined level at a predetermined updating time; and
recording, at the server, a time of updating to the profile of the file.
